(19) United States
(12) Patent Application Publication
(10) Pub. No.: US 2009/0320805 A1
(43) Pub. Date: Dec. 31, 2009

(54) HEATER FOR FLUIDS

(75) Inventors: Tobias Lang, Herzberg (DE); Piers Catton, Gosport (GB); Ulrich Karsch, Niederkassel (DE); Tho Truong Huynh, Millbrook (GB)

Correspondence Address: GROSSMAN, TUCKER, PERREAULT & PFLEGER, PLLC, 55 SOUTH COMMERICAL STREET, MANCHESTER, NH, 03101, US

(73) Assignee: KAUTEX TEXTRON CVS, LTD., London (GB)

(21) Appl. No.: 12/341,649

(22) Filed: Dec. 22, 2008

Related U.S. Application Data
(60) Provisional application No. 61/015,662, filed on Dec. 20, 2007.

(51) Int. Cl. F02M 31/125; H05B 1/02; F02M 33/00

(52) U.S. Cl. 123/518; 219/494; 123/549

(57) ABSTRACT

To improve environmental protection from hydrocarbon emissions particularly from vehicles a heater for fluids comprising heating elements of an electrically conductive monolith, wherein the heater comprises a passageway for the fluid to be heated with a defined flow direction of the fluid during heating operation, the heater comprising at least two heating elements arranged side by side inside the passageway, so that they are arranged in parallel with respect to the fluid flow, is proposed improved in that one of the at least two heating elements is a controlled heating element, which has a slightly larger heating power, and a temperature sensor is provided at or close to the downstream end of the controlled heating element, and wherein the temperature sensor is connected to a control means for temperature control during heating operation of the heater; and a method of operating such

### CROSS-REFERENCE TO RELATED APPLICATIONS

This application claims the benefit of U.S. Provisional Application No. 61/015,662, filed Dec. 20, 2007, the teachings of which are incorporated by reference.

### FIELD

The present invention relates to a heater for fluids comprising heating elements of an electrically conductive monolith, wherein the heater comprises a passageway for the fluid to be heated with a defined flow direction of the fluid during heating operation, the heater comprising at least two heating elements arranged side by side inside the passageway, so that they are arranged in parallel with respect to the fluid flow, a fuel vapor storage and recovery apparatus comprising such a heater, and a method of operating the same.

### BACKGROUND

A heater of that kind is known from US 2007/0056954 A1. Particularly, the application of such a heater is described with respect to a purge heater for a fuel vapor storage and recovery apparatus for the reduction of evaporative emissions from motor vehicles. The purge heater disclosed may comprise one or more electric heating elements which are connected to the source of electric energy, such as for instance the battery of the car. The purge heater may, for instance, comprise electrically conductive ceramic as heating elements.

Alternatively, the purge heater may comprise electrically conductive carbon, preferably porous monolithic carbon. Such porous monolithic carbon is, for instance, disclosed in US 2007/0056954 A1. These monolithic carbon heating elements have a channel structure allowing air flow through the heating elements and thus allowing an enhanced heat transfer directly to the purging air sucked from the atmosphere.

An important application of such heaters is a fuel vapor storage and recovery apparatus for the reduction of evaporative emissions from motor vehicles. Fuel vapor storage and recovery apparatuses including a fuel vapor storage canister are well known in the art since years. The gasoline fuel used in many internal combustion engines is quite volatile. Evaporative emissions of fuel vapor from a vehicle having an internal combustion engine occur principally due to venting of fuel tanks of the vehicle. When the vehicle is parked changes in temperature or pressure cause air laden with hydrocarbons to escape from the fuel tank. Some of the fuel inevitably evaporates into the air within the tank and thus takes the form of a vapor. If the air emitted from the fuel tank were allowed to flow untreated into the atmosphere it would inevitably carry with it this fuel vapor.

There are governmental regulations as to how much fuel vapor may be emitted from the fuel system of a vehicle.

Normally, to prevent fuel vapor loss into the atmosphere the fuel tank of a car is vented through a conduit to a canister containing suitable fuel absorbent materials such as activated carbon. High surface area activated carbon granules are widely used and temporarily absorb the fuel vapor.

A fuel vapor storage and recovery system including a fuel vapor storage canister (so-called carbon canister) has to cope with fuel vapor emissions while the vehicle is shut down for an extended period and when the vehicle is being refuelled, and vapor laden air is being displaced from the fuel tank (refuelling emissions).

In fuel recovery systems for the European market normally refuelling emissions do not play an important role since these refuelling emissions are generally not discharged through the carbon canister. However, in integrated fuel vapor storage and recovery systems for the North American market also these refuelling emissions are discharged through the carbon canister.

Due to the nature of the absorbent within the carbon canister it is clear that the carbon canister has a restricted filling capacity. It is generally desirable to have a carbon canister with a high carbon working capacity, however, it is also desirable to have a carbon canister with a relatively low volume for design purposes. In order to guarantee always sufficient carbon working capacity of the carbon canister typically under operation of the internal combustion engine a certain negative pressure is applied to the interior of the canister from an intake system of the engine through a fuel vapor outlet port of the carbon canister. With this atmospheric air is let into the canister to the atmospheric air inlet port to pick up the trapped fuel vapors and carry the same to an intake manifold of the intake system of the engine through the fuel vapor outlet port. During this canister purging mode the fuel vapors stored within the carbon canister are burnt in the internal combustion engine.

Although modern fuel vapor storage and recovery systems are quite effective there is still a residual emission of hydrocarbons led into the atmosphere. These so-called “bleed emissions” (diurnal breathing loss/DBL) are driven by diffusion in particular when there are high hydrocarbon concentration gradients between the atmospheric vent port of the carbon canister and the absorbent. Bleed emissions can be remarkably reduced when it is possible to reduce the hydrocarbon concentration gradient. It is quite clear that this can be achieved by increasing the working capacity of the carbon canister.

However, it should also be clear that only a certain percentage of the hydrocarbons stored in the carbon canister can effectively be purged or discharged during the purging mode. This can be an issue for cars where only a limited time for purging is available, for instance in electro hybrid cars where the operation mode of the internal combustion engine is relatively short.

Another issue arises with the use of so-called flexi fuels which comprise a considerable amount of ethanol. Ethanol is a highly volatile fuel which has a comparatively high vapor pressure. For instance, the so-called E10 fuel (10% ethanol) has the highest vapor generation currently in the market. That means that the fuel vapor uptake of the carbon canister from the fuel tank is extremely high. On the other hand, during normal purging modes of a conventional carbon canister only a certain percentage of the fuel vapor uptake may be discharged. As a result the fuel vapor capacity of an ordinary carbon canister is exhausted relatively fast. The bleed emissions of a fully loaded carbon canister normally then increase to an extent which is beyond the emission values given by law.

In order to improve the purge removal rate during the purging mode few vapor storage and recovery devices have been proposed which use so-called purge heaters. By heating the atmospheric air which is led into the canister through the atmospheric air inlet port the efficiency of removing the hydrocarbons trapped in the micropores of the absorbent is enhanced remarkably.

For instance, U.S. Pat. No. 6,230,693 B1 discloses an evaporative emission control system for reducing the amount of fuel vapor emitted from a vehicle by providing an auxiliary canister which operates with a storage canister of the evaporative emission control system. The storage canister contains a first sorbent material and has a vent port in communication therewith. The auxiliary canister comprises an enclosure, first and second passages, a heater and a connector. Inside the enclosure a second sorbent material is in total contact with the heater. During a regenerative phase of operation of the control system the heater can be used to heat the second sorbent material and the passing purge air. This enables the second and first sorbent material to more readily release the fuel vapor they absorbed during the previous storage phase of operation so that they can be burnt during combustion.

Moreover, the storage canister of the evaporative emission control system according to U.S. Pat. No. 6,230,693 comprises two fuel vapor storage compartments side by side connected by a flow passage. In particular the partitioning of the canister actually means a flow restriction. Because the driving pressure of the flow through the canister is very low it is an important design consideration that flow restrictions be kept to a minimum.

### SUMMARY

It is an object of the present invention to provide a heater for fluids comprising heating elements of an electrically conductive monolith, wherein the heater comprises a passageway for the fluid to be heated with a defined flow direction of the fluid during heating operation, the heater comprising at least two heating elements arranged side by side inside the passageway, so that they are arranged in parallel with respect to the fluid flow, which is simple, compact and reliable in design and allows easy and efficient controlled operation, and a fuel vapor storage and recovery apparatus which has an improved fuel recovery efficiency. It is yet another object to provide a method for operating such a heater which allows easy and efficient controlled operation

These and other objects are achieved by a heater for fluids comprising heating elements of an electrically conductive monolith, wherein the heater comprises a passageway for the fluid to be heated with a defined flow direction of the fluid during heating operation, the heater comprising at least two heating elements arranged side by side inside the passageway, so that they are arranged in parallel with respect to the fluid flow, characterized in that one of the at least two heating elements is a controlled heating element, which has a slightly larger heating power, and a temperature sensor is provided at or close to the downstream end of the controlled heating element, and wherein the temperature sensor is connected to a control means for temperature control during heating operation of the heater.

The arrangement according to the invention provides both for improved safety and improved efficiency of such a heater. The arrangement of the temperature sensor with a heating element which has a slightly larger heating power ensures that the heater is effectively controllable to a maximum temperature, thus preventing overheating of the heater to prevent the risk of fire on the one hand, on the other hand allowing to control the temperature close to the maximum temperature, thus increasing the efficiency of the heater. Arrangement of the temperature sensor at or close to the downstream end of the heating element minimizes the influence of a varying flow rate of the fluid, i.e. significantly reducing the adverse effects of flow variations on the heating performance of the heater.

With the advantages of the invention described above a fuel vapor storage and recovery apparatus comprising a heater according to the invention is particularly effective for cars having cycle operation of the engine, e.g. petrol/electric hybrid drive. It is typical for such kind of drive that the purge air flow through the fuel vapor storage and recovery apparatus exhibits a rapid change from high to low when the engine is shut off when switching to electrical drive. With conventional design heater such rapid change of purge air flow provides a high risk of overheating of the fuel vapor storage and recovery apparatus with a significant risk of fire, or the heater needs to be controlled to a temperature well below the critical temperature, thus, providing bad recovery performance. However, recovery performance is critical with this kind of application due to the reduced operating time of the petrol engine.

A particularly useful and fail-safe embodiment of the invention is characterized in that the at least two heating elements are electrically in series connection with each other, and the controlled heating element has a larger resistance than the other heating elements.

An alternative embodiment is characterized in that at least two of the heating elements are electrically in parallel connection with each other, and the controlled heating element has a smaller resistance than the other heating elements.

Further useful embodiments of the invention are characterized in that the heater comprises more than two heating elements, and the heating elements are grouped together, wherein the heating elements of one group are electrically in series connection with each other, and the groups of heating elements are electrically in parallel connection with each other group, wherein the group comprising the controlled heating element has a smaller resistance than the other groups of heating elements, and the controlled heating element has a larger resistance than the other heating elements of the same group or in that the heater comprises more than two heating elements, and the heating elements are grouped together, wherein the heating elements of one group are electrically in parallel connection with each other, and the groups of heating elements are electrically in series connection with each other group, wherein the group comprising the controlled heating element has a larger resistance than the other groups of heating elements, and the controlled heating element has a smaller resistance than the other heating elements of the same group.

A preferred embodiment of the heater according to the invention is characterized in that the heating elements comprise an electrically conductive carbon monolith, which carbon monolith is a porous carbon monolith having a cell structure permitting a significant part of the fluid flow to pass through said monolith inside the passageway particularly, when the porous carbon monolith has channels with a channel size between 100 μm and 2000 μm, more particularly, when the porous carbon monolith has an open area between 30% and 60% in the cross section perpendicular to the flow path in the passageway.

A particularly good performance of the heater according to the invention in a typical car environment with conventional 12 V DC power supply can be obtained if the heating elements are arranged to a total resistance not exceeding 2.5 Ohms, preferably not exceeding 1 Ohm, more preferably about 0.8 Ohms.

A heater according to the invention is particularly protected against risk of fire in case of short circuiting of the temperature sensor connection when the temperature sensor is a thermistor.

The above and other objects are further achieved by a fuel vapor storage and recovery apparatus comprising such a heater, and by a method for operating such a heater or fuel vapor storage and recovery apparatus in a vehicle environment, comprising the following steps: obtaining a refuelling signal indicating that a vehicle tank in fluid communication with the heater has been refuelled, and energizing the heater after refuelling from start of engine for no more than 45 min/24 hours, preferably for about 30 min/24 hours, while controlling electrical power to the heater in response to a temperature signal from a temperature sensor.

In a preferred embodiment of the method according to the invention, the method further comprises the following steps: obtaining a fuel level signal from a fuel gauge, and preventing the heater from being energized if the fuel level signal indicates the fuel level being down to a predetermined reading, wherein the predetermined reading is ⅓, preferably ¼ of the fuel tank capacity. At such low fuel levels the fuel vapor generation does not provide significant increase of the pressure in the tank. Accordingly, there is only a small vapor load of a fuel vapor storage and recovery apparatus and the recovery efficiency is well sufficient with no heating at any ambient temperature. Further, when the tank will be refueled subsequently, and fuel vapor will flow through the carbon canister at high flow rates in integrated systems, the emission reduction efficiency of the carbon canister is much better with a cold carbon bed in the canister due to exothermic effects during adsorption.

Energy saving can also be reached by de-energizing the heater under all operating conditions if environmental temperature is below a predetermined figure, preferably below −7° C., more preferably, below −10° C. At such low temperatures, fuel vapor generation inside the fuel tank is relatively low and the fuel vapor storage and recovery apparatus will be sufficiently effective even with no heating.

Energy loss through heat sink can be minimized and, thus, electrical power can be saved when the controlling of electrical power supplied to the heater comprises pulse-width modulation of the electrical power supplied to the heater.

In a particularly preferred embodiment the method further comprises the step of performing at least one test cycle, and de-energize heater, and send fault signal to an on board diagnostics system if one or more of the following conditions are met: fault detected in temperature sensor circuitry, self test of heater control failed, increase of resistance of monolith heater element arrangement beyond a predetermined figure detected, and supply voltage exceeds or falls below a predetermined maximum/minimum figure. More preferably, the fault detected in temperature sensor circuitry comprises one of the following: open circuit of a thermistor circuitry, short circuit of a thermistor circuitry, and poor thermistor contact. Considering the fact that improper operation, particularly uncontrolled heating, may cause the risk of fire, this embodiment provides for improved fail-safe operation.

The detection of an increase in the resistance of the monolith heater element arrangement is an indication of a failure in one of the heater elements or a disconnection. This is further an indication that failure of operation of the heater is to be expected, and thus, of a fuel vapor storage and recovery apparatus, such a heater is used with. With this embodiment of the method according to the invention the legal requirements of on board diagnosis of emission control equipment can be met.

Best recovery performance and secure operation is obtained when electrical energy to the heater is controlled to a temperature at the temperature sensor of about 132° C. to about 145° C., preferably to about 140° C.

### BRIEF DESCRIPTION OF THE DRAWINGS

The invention will hereinafter be described by way of a non-limiting example with reference to the accompanying drawings, in which:

FIG. 1 shows a schematic view of a heater according to the invention including a simplified wiring scheme;

FIG. 2 shows an enlarged cross-sectional view of two adjacent heater element end sections;

FIG. 3 shows a cross-sectional view in the plane indicated in FIG. 2; and

FIG. 4 shows a cross-sectional view through a carbon canister comprising a heater according to the invention.

### DETAILED DESCRIPTION

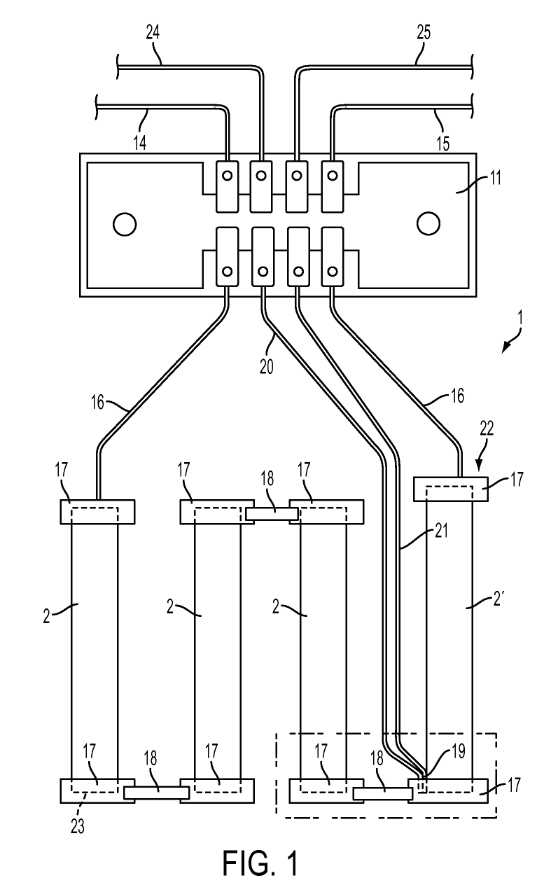

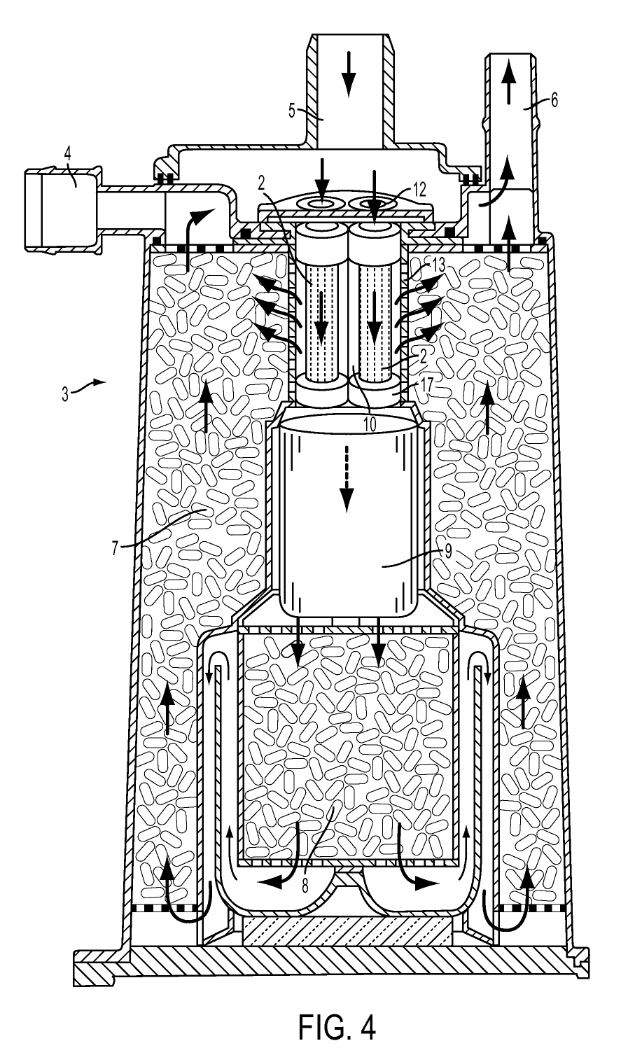

FIG. 1 depicts schematically a heater for fluids according to one embodiment of the invention, generally designated as 1. The heater 1 comprises heating elements 2 of an electrically conductive monolith. The heater 1 according to the invention may be good used with a fuel vapor storage and recovery apparatus 3 as illustrated in FIG. 4. Such a fuel vapor storage and recovery apparatus 3 is usually called a carbon canister and typically employed as a part of an emission control system of a motor vehicle having a petrol feeded engine. The illustration is schematic and the components are not drawn to scale.

The fuel vapor storage and recovery apparatus or carbon canister 3 comprises a vapor inlet port 4 connected to a fuel tank (not shown), a vent port 5 communicating with the atmosphere and a purge port 6 connected to an internal combustion engine of a motor vehicle (also not shown). The carbon canister 3 is packed with an adsorbent in the form of granulated activated carbon.

During shut-off of the engine of the motor vehicle the carbon canister 3 is connected via vapor inlet port 4 to the fuel tank of the motor vehicle and via vent port 5 to the atmosphere. During engine running cycles of the car a flow path between the vent port 5 and the purge port 6 will be established. The internal combustion engine sucks a certain amount of air to be burnt within the combustion chambers of the internal combustion engine from the atmosphere via vent port 5 through the carbon canister 3 into the purge port 6, thereby purging the absorbent of the carbon canister 3 and feeding the hydrocarbons removed from the carbon canister to the combustion chamber of the engine. In the drawings arrows indicate the air flow path during purging of the carbon canister 3. The terms “downstream” and “upstream” in the context of this application always refer to the airflow during purging of the carbon canister 3, that is defined as the flow direction of the fluid during heating operation.

The carbon canister 3 comprises first 7, second 8 and third 9 vapor storage compartments. The first vapor storage compartment 7 is with regard to the airflow during upload of hydrocarbons to the carbon canister 3 the vapor storage compartment next to the vapor inlet port 4 and is also the biggest vapor storage compartment.

It will be readily apparent from FIG. 4 that the vapor storage compartments 7, 8, 9 have a circular cross-section and are arranged in concentric relationship to each other. The first vapor storage compartment 7 surrounds the vapor storage compartments 8 and 9. Next to the vent port 5 at the upstream side of the third vapor storage compartment 9 there is arranged a purge heater compartment 10 which has also a cylindrical shape, i.e. a circular cross-section.

The purge heater compartment 10 has at its upstream face two inlet openings 12 allowing atmospheric air to be drawn into the purge heater compartment 10. The purge heater compartment 10 has a relatively thin-walled surrounding wall 13 which is designed such that heat radiation from the heater 1 may be transferred into the surrounding carbon bed of the first vapor storage compartment 7. The surrounding wall 13 of the heater 1 defines a passageway for the fluid, that is the air-flow through the heater 1.

As can be easily seen from FIGS. 1 and 4 the heater 1 preferably comprises four heating elements 2 arranged side by side inside the heater compartment 10 forming the passageway. With respect to the air flow through the heater compartment 10, the heating elements 2 are arranged in parallel.

The heating elements 2 may be of cylindrical shape and comprise an electrically conductive porous carbon monolith, such as for instance, a synthetic carbon monolith. A method of manufacturing such carbon monolith heating elements 2 is generally disclosed in US 2007/0056954 A1, and in more detail in paragraphs [0013] to [0024], hereby incorporated by reference. The carbon monolith is a porous carbon monolith having a cell structure permitting a significant fluid flow to pass through said monolith. Each heating element 2 provides continuous longitudinal channels (not shown) allowing a gas fluid flow in longitudinal direction through each heating element 2. The channels inside the porous carbon monolith may have a size between 100 μm and 2000 μm. The porous carbon monolith heating element has an open area between 30% and 60% in the cross section perpendicular to the flow path in the passageway.

A suitable typical heating element 2 may have a diameter of approx. 10 mm and a typical length of about 50 mm. The heating elements 2 operate as a resistive heating element, each. In a preferred embodiment shown in the drawings, the four electric heating elements 7 are electrically connected in series and connected to a control and switching means 11, which in turn is connected to a source of electric energy as the generator and battery of the vehicle through negative and positive power lines 14 and 15.

The heating elements 2 are connected to the control and switching means 11 via power line 16 and copper connectors 17. The interconnection of the heating elements 2 is provided by connectors 18. The arrangement of the heating elements 2 provide a total resistance of no more than 2.5 ohms, preferably about 0.8 ohms. To provide a heating power of approx. 75 watts at a supply voltage of 13.7 V some kind of power regulation is required.

A suitable method of controlling the power supplied is pulse-width modulation (PWM). The main advantage of this method is the low power loss in the control and switching means 11. Although PWM operation requires some additional electrical components to minimize adverse feedback in the onboard power supply network and to provide electromagnetic compatibility (EMC), the control and switching means 11 itself could be less expensive. Additionally, space and probably ventilation for a large heat sink required otherwise can be saved, giving an overall advantage in costs and space required.

However, conventional current regulator circuiting can be used as well, but requires cooling. Conventional current regulation may be advantageous if the dissipated heat can be used for some other purposes.

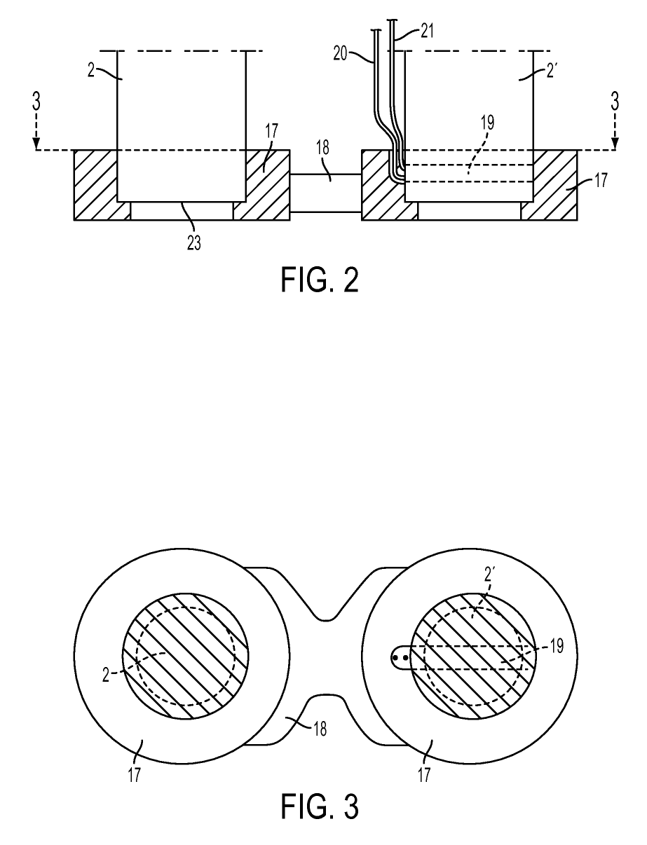

One of the heating elements 2 has a slightly larger heating power than the other heating elements 2. This heating element defines a controlled heating element 2′. A temperature sensor in the form of a thermistor 19 is provided at or close to the downstream end 23 of the controlled heating element 2′. The temperature sensor 19 is connected to the control means 11 via wires 20 and 21 for temperature control during heating operation of the heater 1. In the depicted embodiment of four heating elements 2, 2′ connected in series, the controlled heating element 2′ has a slightly larger length than the other heating elements 2, e.g. 53 mm. With the same diameter, and thus the same cross sectional area, the controlled heating element 2′ shows a slightly larger resistance than the other heating elements 2. Preferably, the thermistor 19 is mounted approx. 50 mm from the upstream end 22 of the controlled heating element 2′, corresponding to the position of the downstream end 23 of the other heating elements 2, inside an opening in the downstream end section of the controlled heating element 2′, as shown in more detail in FIGS. 2 and 3. This arrangement is just to ensure that the thermistor 19 detects the temperature at the hottest part of the heater.

The control and switching means 11 is further connected to an on board diagnostic system via data line 24, and other devices of the vehicle, e.g. via CAN bus line 25. Of course, other suitable wiring is possible as easily apparent for a person skilled in the art.

The heating elements 2 will only be activated during the purging operation of the fuel vapor storage and recovery apparatus 3, as described in more detail below.

As explained above, during shut-off of the car the fuel within the fuel tank evaporates into the air space above the maximum filling level of the fuel tank. This vapor laden air flows via vapor inlet port 4 into the carbon canister 3. During refuelling of the car, where normally the internal combustion engine is also shut off, in so-called integrated systems the fuel being pumped into the fuel tank causes an air flow through the vapor inlet port 4 the flow rate of which corresponds to the flow rate of refuelling. Accordingly, hydrocarbon laden air is pumped with a flow rate of up to 60 liters/min into the carbon bed of the carbon canister 3. The activated carbons within the carbon canister absorb the hydrocarbons, hydrocarbon molecules being trapped within the internal pore structure of the carbon. More or less cleaned air will be discharged from the vent port 5. Adsorption efficiency at such high flow rates is better if the carbon bed is cold due to exothermic effects coming with the adsorption. Therefore, suppressing heating operation of the heater 1 at low fuel levels in the fuel tank is advantageous in view of refuelling to be expected.

During running cycles of the internal combustion engine of the vehicle the fuel vapor storage and recovery apparatus 3 according to the invention is set to purge mode. Atmospheric air is drawn from the internal combustion engine of the vehicle from the vent port 5 via inlet opening 12 into the purge heater compartment 10. The heating elements 2 are electrically energized from the generator or battery of the vehicle during purging. The air flows through and around the heating elements 2 thereby being heated up to a temperature below but in any case not exceeding 150° C. At the same time radiation heat emitted by the heating elements 2 heats up the surrounding carbon bed of the first vapor storage compartment 7. Heated air flows through the third vapor storage compartment 9. On its way the atmospheric air will be loaded by the hydrocarbons stored in the carbon beds. This air flow, as indicated by the arrows in FIG. 4 flows into and through the carbon bed of the first vapor storage compartment 7 and is finally drawn through the purge port 6 to a purging line leading to the internal combustion engine.

The method of operating a heater 1 used in a fuel vapor storage and recovery apparatus 3 in a vehicle environment comprises the following steps: obtaining a refuelling signal through CAN bus 25 indicating that the vehicle tank has been refuelled. Such signal can be obtained from a fuel cap switch detecting a closed fuel cap. If the signal is present, the heater 1 will be energized from the start of the engine for no more than 45 min within 24 hours, preferably for about 30 min per 24 hours, while controlling electrical power to the heater 1 in response to a temperature signal from the temperature sensor 19. With the embodiment described above, the thermistor 19 is calibrated to a temperature of 140° C., providing the best compromise between recovery efficiency and safety.

Further, a fuel level signal will be obtained from a fuel gauge also through CAN bus 25, and the heater 1 will not be energized if the fuel level signal indicates the fuel level being down to a predetermined reading, preferably ¼ of the fuel tank capacity, for the reasons described above with respect to refueling.

Energy saving can be reached by de-energizing the heater 1 under all operating conditions if environmental temperature is below a predetermined figure, e.g. −10° C. The outside temperature signal may also be provided via CAN bus 25 or otherwise obtained from the motor management system. The control and switching means 11 preferably performs at least one test cycle e.g. prior to energizing the heater 1, and de-energize heater 1, and send fault signal to the on board diagnostics system via data line 24 if one or more of the following occurs: a fault is detected in the circuitry of the thermistor 19 and wires 20 and 21, a self test of heater control 11 failed, or increase of the resistance of the monolith heater element 2 beyond a predetermined figure is detected, thus, indicating a failure in one of the heating elements 2 such as a cracked monolith or a disconnection, etc. A damaged heating element 2 or disconnection will make the carbon canister 3 as a part of emission control system ineffective, and malfunction needs to be indicated to the driver. Preferably, a limp-home mode will be activated to allow the driver to return home and take the car to a repair shop.

A fault detected in the temperature sensor circuitry 19, 20, 21 comprises one of the following: open circuit of the wiring 20, 21, a short circuit of the thermistor 19, and poor thermistor 19 contact. Considering the fact that improper operation, particularly uncontrolled heating, may cause the risk of fire, this embodiment provides for improved fail-safe operation.

In addition, the heater 1 will be de-energized by the control and switching means 11 in case the supply voltage exceeds or falls below predetermined maximum/minimum voltage figures to avoid damage or malfunction, like overheating.

Best recovery performance and secure operation is obtained when the electrical energy to the heater 1 is controlled by the control and switching means 11 to a temperature at the temperature sensor 19 of about 132° C. to about 145° C., preferably to about 140° C., thus preventing that no part of the heater 1 which is in contact with air/petrol vapor mixture permanently exceeds 150° C.

What is claimed is:

1. A heater for fluids comprising heating elements of an electrically conductive monolith, wherein the heater comprises a passageway for the fluid to be heated with a defined flow direction of the fluid during heating operation, the heater comprising at least two heating elements arranged side by side inside the passageway, said at least two heating elements arranged in parallel with respect to the fluid flow, characterized in that one of the at least two heating elements is a controlled heating element having a larger heating power and a downstream end, and a temperature sensor provided at or approximate the downstream end of the controlled heating element, and wherein the temperature sensor is connected to a control means for temperature control during heating operation of the heater.

2. The heater according to claim 1, characterized in that the at least two heating elements are electrically connected in series with each other, and the controlled heating element has a larger resistance than the other of the at least two heating elements.

3. The heater according to claim 1, characterized in that the at least two heating elements are electrically connected in parallel with each other, and the controlled heating element has a smaller resistance than the other of the at least two heating elements.

4. The heater according to claim 1, characterized in that the heater comprises more than two heating elements, and the heating elements are grouped together, wherein the heating elements of a first group are connected electrically in series with each other, and the heating elements of a second group are connected electrically in parallel with each other, wherein one of the first and second groups includes said controlled heating element and the group including said controlled heating element has a smaller resistance than the other group, and the controlled heating element has a larger resistance than the other heating elements of the same group.

5. The heater according to claim 1, characterized in that the heater comprises more than two heating elements, and the heating elements are grouped together, wherein the heating elements of a first group are connected electrically in parallel with each other, and the heating elements of a second group are connected electrically in series with each other, wherein one of said first and said second groups includes said controlled heating element and said controlled heating element has a larger resistance than the other heating elements of the same group, and the controlled heating element has a smaller resistance than the other heating elements of the same group.

6. The heater according to claim 1, characterized in that the at least two or more heating elements comprise an electrically conductive carbon monolith, which carbon monolith is a porous carbon monolith having a cell structure permitting a significant part of the fluid flow to pass through said monolith inside the passageway.

7. The heater according to claim 6, characterized in that the porous carbon monolith has channels with a channel size between 100 μm and 2000 μm.

8. The heater according to claim 6, characterized in that the porous carbon monolith has an open area between 30% and 60% in the cross-section perpendicular to the flow path in the passageway.

9. The heater according to claim 1, characterized in that the at least two or more heating elements are arranged to a total resistance in the range of about 0.8 Ohms to about 2.5 Ohms.

10. The heater according to claim 1, wherein the temperature sensor is a thermistor.

11. A fuel vapor storage and recovery apparatus comprising a heater according to claim 1, and a control.

12. A method for operating a heater according to claim 1 in a vehicle environment, comprising the following steps:
i) obtaining a refueling signal indicating that a vehicle tank in fluid communication with the heater has been refueled, and
ii) energizing the heater after refueling from start of engine for no more than 45 min within 24 hours,
while controlling electrical power supplied to the heater in response to a temperature signal from a temperature sensor.

13. The method according to claim 12, characterized in that the energizing of step ii) is for about 30 min within 24 hours.

14. The method according to claim 12, further comprising the step of
iii) obtaining a fuel level signal from a fuel gauge, and
iv) preventing the heater from being energized if the fuel level signal indicates the fuel level being at or below a predetermined tank level reading.

15. The method according to claim 14, characterized in that the predetermined reading of step iv) is ⅓ of the fuel tank capacity.

16. The method according to claim 12, further comprising the step of
v) de-energizing the heater under all operating conditions if the environmental temperature is below a predetermined temperature.

17. The method according to claim 16, characterized in that the predetermined temperature of step v) is −10° C.

18. The method according to claim 12, further comprising the step of performing at least one test cycle, de-energizing the heater, and sending a fault signal to an on-board diagnostics system if one or more of the following conditions are met:
a) a fault is detected in temperature sensor circuitry,
b) a failure is detected in the self test of the heater control,
c) an increase of resistance of the monolith heater element arrangement beyond a predetermined figure is detected, or
d) the supply voltage exceeds or falls below a predetermined minimum figure.

19. The method according to claim 18, characterized in that the fault detected in temperature sensor circuitry comprises one of the following:
an open circuit of a thermistor circuitry,
a short circuit of a thermistor circuitry, and
a poor thermistor contact.

20. The method according to claim 12, wherein the provision of electrical energy to the heater is controlled to a temperature at the temperature sensor of about 132° C. to about 145° C.

21. The method according to claim 12 wherein the controlling of electrical power supplied to the heater comprises pulse-width modulation of the electrical power supplied to the heater.
